(19) United States
(12) Patent Application Publication
(10) Pub. No.: US 2007/0251399 A1
(43) Pub. Date: Nov. 1, 2007

(54) Device for Cutting a Fruit or Vegetable in a Helical Shape

(76) Inventor: Hermanus Willem Van Heerden, Pretoria (ZA)

Correspondence Address: SUTHERLAND ASBILL & BRENNAN LLP, 999 PEACHTREE STREET, N.E., ATLANTA, GA, 30309, US

(21) Appl. No.: 10/561,507

(22) PCT Filed: Jun. 18, 2004
(86) PCT No.: PCT/IB04/02034

§ 371 Date: Jan. 25, 2007

(30) Foreign Application Priority Data
Jun. 20, 2003 (ZA) 2003/4785

(51) Int. Cl. A47J 17/16; A23N 7/02

(52) U.S. Cl. 99/596

(57) ABSTRACT

The invention provides a device (10) for helically slicing a potato. The device (10) includes a sleeve (22) and a chuck (44) connected to the sleeve (22), the chuck (44) being rotatable about an axis of rotation (42) and including a skewer holder for holding a skewer (32) such that the skewer (32) is co-axial with the axis (42). A blade (56) is mounted on the sleeve (22) for linear displacement in a direction parallel to the axis (42), the blade (56) having a radially extending cutting edge (60) and being anchored against rotation relative to the sleeve (22). The blade (56) is shaped to abut a potato on the skewer (32), but to permit a free end of the skewer (32) to pass through it, so that synchronous rotation and the chuck (44) and linear displacement of the blade (56) results in helical slicing of a skewered potato.

THIS INVENTION relates to a device for cutting a fruit or a vegetable in a helical shape. The invention extends to a kit for cutting a fruit or vegetable, typically a potato, in a helical shape. The invention also relates to a method of cutting a fruit or vegetable in a helical shape.

The invention provides a device for slicing a fruit or vegetable in a helical shape, which device includes:

a frame;

a chuck which is connected or connectable to the frame, the chuck being rotatable relative to the frame about an axis of rotation and the chuck including a skewer holder for holding a skewer such that the skewer is more or less co-axial with the axis of rotation;

a keying means for rotationally keying to the chuck a fruit or vegetable on a skewer held by the skewer holder, so that the fruit or vegetable is rotatable with the chuck about the axis of rotation;

a blade member which is mounted on the frame for linear displacement in a direction parallel to the axis of rotation, the blade member having a cutting edge which extends more or less radially relative to the axis of rotation and the blade member being anchored against rotation relative to the frame,

the blade member being shaped to abut a fruit or vegetable held on the chuck by the skewer, but to permit a part of the skewer to pass through the blade member, so that synchronous rotation and the chuck and linear displacement of the blade member results in helical slicing of a fruit or vegetable held on the chuck.

The blade member typically extends transversely to the axis of rotation of the chuck and includes a centering aperture which is co-axial with the axis of rotation, the centering aperture being configured for receiving a skewer held on the chuck, to ensure that the skewer is co-axial with the chuck's axis of rotation.

The frame may be a tubular element having a hollow interior and open ends, the blade member being mounted or mountable in the hollow interior of the tubular element to extend transversely to a longitudinal axis of the tubular element, the blade member substantially closing off the hollow interior of the frame, to separate the interior of the frame into two compartments. The lower end of the tubular frame may be shaped to serve as a base on which the frame can stand upright, in use.

The blade member is preferably a part-helical disc-shaped element in which the cutting edge is spaced from an adjacent edge of the element to define a cutting gap through which a cut portion of a fruit or vegetable can pass in response to rotation of the fruit or vegetable. It will be appreciated that the blade member is thus shaped to cut through the fruit or vegetable in a screwing action, so that rotation of the fruit or vegetable relative to the rotationally keyed blade member automatically results in linear displacement of the blade member towards the chuck.

The blade member may be mounted on a carriage which is longitudinally slidable along the interior of the frame, the device including an urging means for urging the carriage towards the chuck. In a preferred embodiment, the urging means includes a spring means which acts between the frame and the carriage, the spring means typically being a compression spring which is housed in the hollow interior of the frame, bearing against a seat therefor adjacent a lower end of the frame; and bearing against the carriage.

The carriage may have a circumferentially spaced series of axially extending radially outwardly projecting splines for reception in complementary axially extending grooves in a radially inner wall of the frame, to permit sliding displacement of the carriage along the frame while keying the carriage to the frame.

The blade member may optionally be removably and replaceably mounted on the carriage. Conveniently, the blade member has keying formations for co-operation with complementary keying formations on the carriage, to key the blade member rotationally to the carriage. The keying formations on the blade member and the carriage may advantageously be arranged to ensure a desired orientation of the blade member when the respective keying formations are engaged.

The carriage may include a locking member for holding the blade member in position on the carriage, the locking member being arranged for snap fit connection.

The chuck may be provided on a removable closure member or lid for reception on an upper end of the frame, the chuck projecting into the hollow interior of the frame and the device including a crank handle provided on an upper side of the closure member for manual operation, to rotate the chuck. The crank handle will typically be arranged for rotation about the rotational axis of the chuck.

The device may include a locking arrangement for locking the closure member to the upper end of the frame, to anchor the closure member against longitudinal displacement relative to the frame.

In one embodiment of the invention, the skewer holder comprises an elongated blind bore defined by the chuck, the bore being co-axial with the axis of rotation of the chuck. In such case, the keying means for keying a fruit or vegetable to the chuck may comprise at least one keying protrusion which is fast with the chuck and projects axially from the chuck towards the interior of the frame for piercing a fruit or vegetable on a skewer held by the chuck.

The tubular body of the frame is of a substantially transparent polymeric plastics material, to permit viewing of the linear position of the blade member or the carriage in the frame.

According to another aspect of the invention, there is provided a device for slicing a fruit or vegetable in a helical shape, which device includes:

a frame;

a chuck which is connected to the frame for holding a fruit or vegetable to be sliced such that the fruit or vegetable is rotationally keyed to the chuck;

a rotating means for rotating the chuck and therefore a fruit or vegetable which is connected to the chuck about a rotational axis;

a blade member which is mounted on the frame for linear displacement in a direction parallel to the rotational axis, the blade member being anchored against rotation relative to the frame, and the blade member having a cutting edge which extends radially relative to the rotational axis; and

an urging means for automatically urging the blade member towards the chuck such that a flat part of the blade member abuts a fruit or vegetable held on the chuck, resisting linear displacement of the blade member by the urging means, and for displacing the blade member towards the chuck when the chuck is rotated so that the vegetable or fruit is sliced by the blade member.

The invention extends to a kit for slicing a fruit or vegetable in a helical shape, which kit includes:

a cutting device as defined above;

a plurality of skewers for reception in the skewer holder of the chuck; and

an awl device for making a rectilinear hole in a fruit or vegetable such that the hole extends through the fruit or vegetable, for reception of one of the skewers therein.

The invention further provides a method of cutting a fruit or a vegetable in a helical shape, which method includes:

skewering the fruit or vegetable by passing a skewer through the fruit or vegetable;

mounting the skewer on a rotatable chuck of a cutting device such that the skewer is co-axial with an axis of rotation of the chuck, and passing a free end of the skewer, remote from the chuck, through a centering aperture in a blade member of the device, an end of the fruit or vegetable remote from the chuck bearing against the blade member;

keying the fruit or vegetable to the chuck for rotation therewith;

rotating the fruit or vegetable and the skewer in a cutting direction by rotating the chuck, so that the fruit or vegetable engages a cutting edge provided by the blade member; and

displacing the blade member towards the chuck during rotation of the chuck, the blade member being keyed against rotation about the axis of rotation, so that the fruit or vegetable is screwed through the blade member as the blade member moves upwards, the skewer passing through the blade member with the fruit or vegetable.

The method may include removing the skewer, and therefore a helically cut part of the fruit or vegetable which is connected to the skewer, from the device by disengaging the skewer from the chuck.

The skewer and the helically cut part of the fruit or vegetable is removed from an end of a tubular body of the device opposite to an end of the device at which the chuck is located.

The method may include urging the blade member towards the chuck by a spring means which acts between the blade member and the frame.

The invention will now be further described, by way of example, with reference to the accompanying diagrammatic drawings, in which:

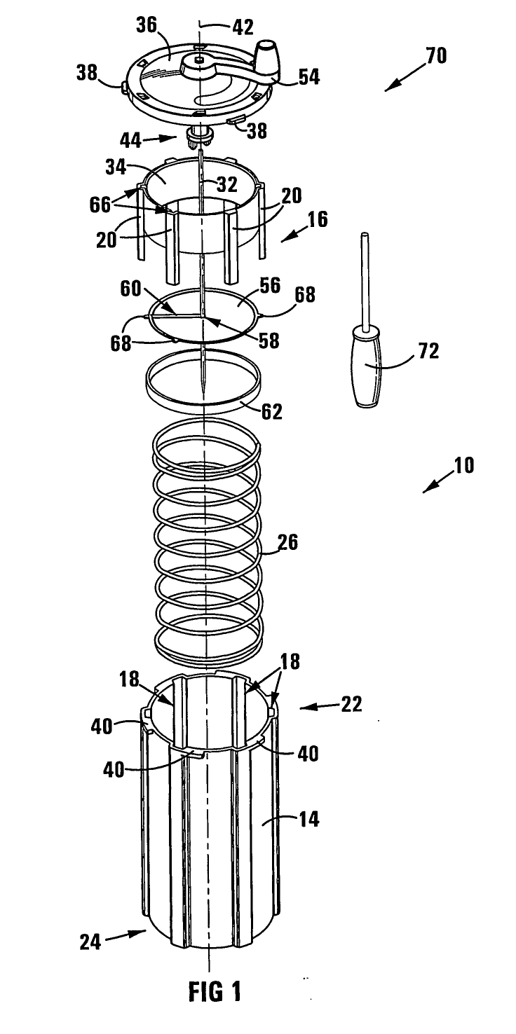

FIG. 1 is an exploded three-dimensional view of a kit for spirally slicing a potato in accordance with the invention, the kit including a device for slicing a fruit or vegetable in accordance with the invention;

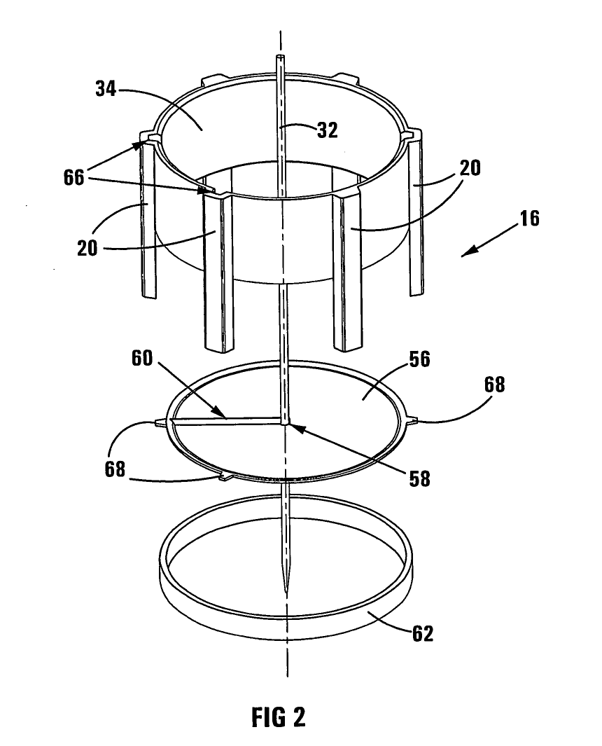

FIG. 2 is, on an enlarged scale, a view corresponding to FIG. 1 of a blade member carriage unit forming part of the device of FIG. 1;

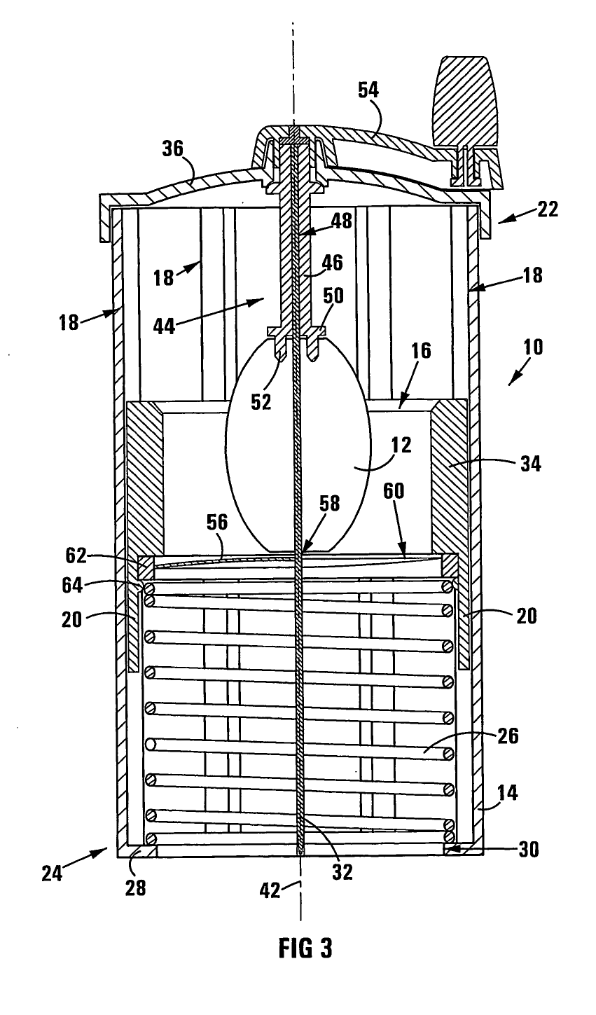

FIG. 3 is a sectional side view of the device of FIG. 1, during the slicing of a potato;

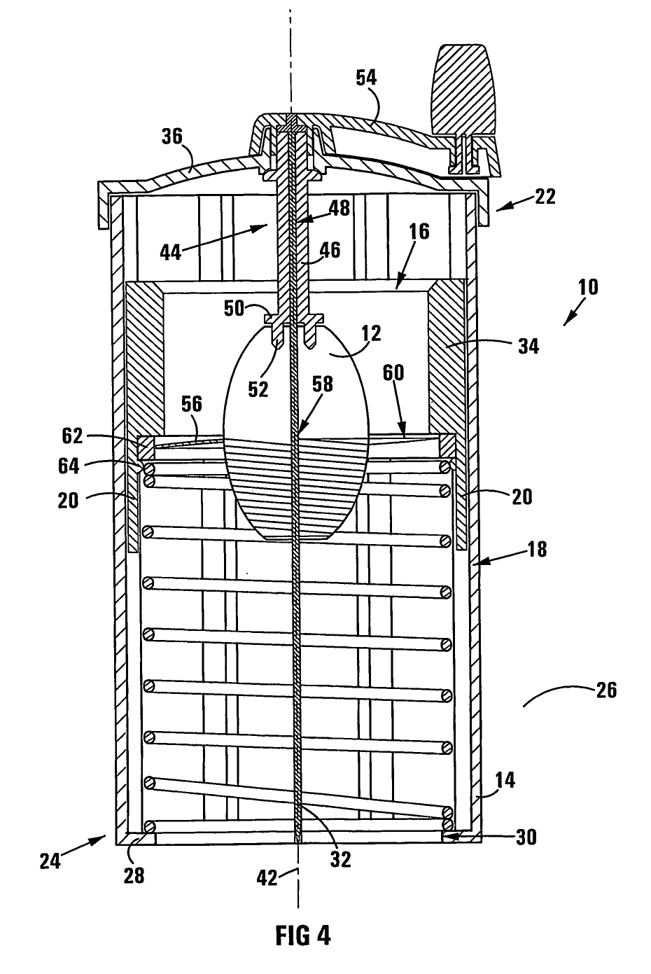

FIG. 4 is a view corresponding to FIG. 3, the potato being shown in an advanced stage of slicing; and

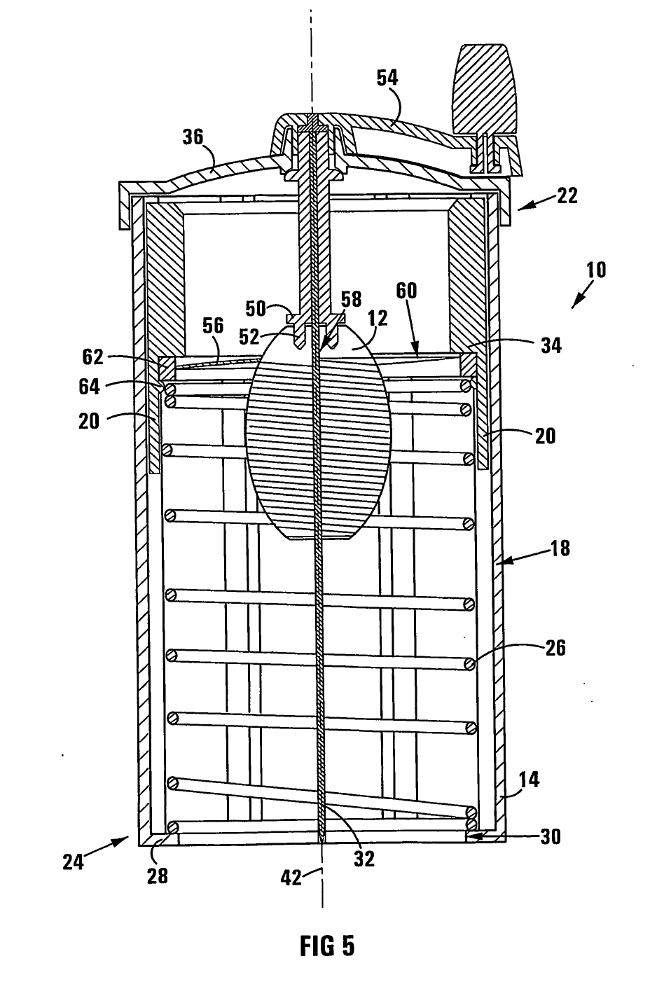

FIG. 5 is a view corresponding to FIG. 3, after slicing of the potato has been completed.

In the drawings, reference numeral 10 generally indicates a device or appliance for use in cutting a fruit or vegetable, typically a potato 12, in a helical shape.

The device 10 includes a frame in the form of a more or less circular cylindrical tubular sleeve 14 in which a blade carriage unit 16 is longitudinally slidably receivable. The sleeve 14 has a plurality of axially extending grooves 18 or flutes in its radially inner wall, while the carriage unit 16 has complementary ribs or splines 20 which project radially outwardly and extend axially for sliding reception in the grooves 18 of the sleeve 14.

When the carriage unit 16 is thus telescopically received in the sleeve 14 such that the carriage unit 16 and the sleeve 14 are longitudinally aligned and the splines 20 are sliding received in the grooves 18, the carriage unit 16 is longitudinally slidably displaceable along the hollow interior of the sleeve 14, but is rotationally keyed to the sleeve 14. The carriage unit 16 is anchored against rotation relative to the sleeve 14 by cooperation of the splines 20 and the grooves 18.

The sleeve 14 has an upper end 22 and an opposite lower end 24, the carriage unit 16 being urged or biassed away from the lower end 24 of the sleeve 14 by an urging means in the form of a compression spring 26 which is co-axially housed in the sleeve 14. The spring 26 bears against a seat provided by a peripherally extending radially inwardly projecting rim or flange 28 at the lower end 24 of the sleeve 14, and acts on an underside of the carriage unit 16 to urge it upwardly.

It is important to appreciate that the lower end 24 of the sleeve 14 defines an opening 30 sufficiently large to permit removal of a sliced potato 12 on a skewer 32 from the sleeve 14, in use. The splines 20 on the carriage unit 16 project downwardly from a main part of a carriage body 34, to act as fingers which surround an upper end of the spring 26.

The device 10 further includes a closure member in the form of a lid 36 which is connectable to the upper end 22 of the sleeve 14. The lid 36 includes a locking arrangement for locking the lid 36 to the sleeve 14, to resist longitudinal separation of the lid 36 and the sleeve 14. In this example, the locking arrangement includes a number of circumferentially spaced tabs 38 (not shown in FIGS. 2-5) which project radially outwardly from the lid 36 and are receivable in L-shaped locking niches 40 defined at the rim 22 of the sleeve 14. The entrances to the locking niches 40 coincide with upper ends of the sleeve's grooves 18.

In use, the lid 36 is thus fastened to the sleeve 14 by insertion of the tabs 38 into the complementary niches 40, and pivotal displacement of the lid 36 about the longitudinal axis 42 of the sleeve 14, to turn the tabs 38 into the respective complementary niches 40 or recesses.

The lid 36 includes a chuck 44 or holding means for holding a potato 12 such that the potato 12 projects from the lid 36 towards the carriage unit 16. The chuck 44 comprises a skewer holder for holding a skewer 32, typically a wooden skewer, such that the skewer 32 is aligned with the longitudinal axis 42 of the sleeve 14, the skewer 32 thus being located centrally in the sleeve 14. In this example, the chuck 44 comprises an elongated stem 46 which projects perpendicularly from the lid 36, being co-axial with the longitudinal axis 42 of the sleeve 14 when the lid 36 is mounted on the sleeve 14. The skewer holder comprises a circular cylindrical hole or bore 48 which extends lengthwise along the stem 46 of the chuck 44. The chuck 44 further includes a boss 50 at a lower end of the stem 46, the bore 48 opening out of the boss 50. The skewer holding bore 48 is dimensioned such that the skewer 32 is a frictional fit or a press fit in the bore 48.

The chuck 44 is further configured for holding a potato 12 such that it is rotationally keyed to the chuck 44. To this end, the chuck 44 has a pair of prongs 52 which project axially away from the boss 50. The prongs 52 are designed for insertion into a potato 12 which is mounted on a skewer 32 held by the chuck 44, so that the potato 12, in use, rotates with the chuck 44.

The chuck 44 is rotatable about the longitudinal axis 42 of the sleeve 14, which is thus co-axial with a rotational axis 42 of the chuck 44. To this end, the chuck 44 is connected to a crank handle 54 which is provided on the outer side of the lid 36, so that the chuck 44 is rotatable in response to rotation of the handle 54.

The blade carriage unit 16 includes a blade disc 56 which lies in a plane substantially perpendicular to the longitudinal axis 42 of the sleeve 14. The blade disc 56 includes a central aperture 58 for receiving a skewer 32 held by the chuck's skewer holding bore 48.

The disc 56 further has a cutting edge 60 which extends radially from the central aperture 58, the blade edge 60 being raised relative to a part of the disc 56 immediately adjacent the blade edge 60. In other words, the blade disc 56 is radially split, one of the radially extending edges being more or less parallel to but raised above the other edge, and being sharpened to form a cutting edge 60, so that the blade disc 56 has a helical shape, similar to a single revolution of a screw thread.

The blade carriage unit 16 comprises a tubular body 34 having an outer diameter slightly smaller than the inner diameter of the sleeve 14. As described above, the radially outer surface of the tubular body 34 defines the splines 20 which are receivable in the sleeve's grooves 18.

The tubular body 34 of the carriage unit 16 has a depth somewhat greater than the length of the chuck stem 46 (see FIG. 5), the blade disc 56 being located adjacent the bottom of the tubular body 34. The blade disc 56 is removably and replaceably connected to the body 34 by a locking ring 62 which is co-axially arranged with the sleeve 14 and the carriage body 34. The ring 62 is receivable immediately beneath the blade disc 56 between the splines 20 which project downwardly from the tubular carriage body 34. To locate the ring 62 in position, some of the splines 20 define locking protrusions 64 which project radially inwardly. The ring 62 and the splines 20 are of a polymeric plastics material, so that the ring 62 is configured for being located in position by snap-fit engagement with the splines 20.

To locate the blade disc 56 in position and to key the disc 56 rotationally to the carriage body 34, three of the splines 20 have longitudinally extending grooves 66 in their radially inner surfaces, while the disc 56 has three circumferentially spaced complementary lugs 68 for sliding reception in the grooves 66 of the splines 20. It will be appreciated that the lugs 68 are asymmetrically spaced about the central axis 42, so that the disc 56 needs to have a correct orientation in order for it to be received on the carriage body 34. The arrangement of the grooves 66 in the splines 20 and the lugs 68 thus serves to ensure proper orientation of the blade disc 56.

In this example the sleeve 14 is of a substantially transparent polymeric plastics material, while the lid 36, the carriage body 34, and the locking ring 62 are of an opaque polymeric plastics material. The blade disc 56 and the compression spring 26 are of steel.

The device 10 forms part of a kit 70 which includes a plurality of wooden skewers 32 which are shaped for reception in the chuck holding bore 48 and in the central aperture 58 of the blade disc 56. The kit 70 further includes a brad or awl 72 for making rectilinear mounting passages or holes in potatoes 12 which are to be sliced with the device 10.

In use, the device 10 is employed to slice or cut a fruit or vegetable, typically a potato 12, into helical or spiral form. First, the awl 72 is used to make hole which extends longitudinally through the potato 12 which is to be sliced. Thereafter, one of the skewers 32 is threaded through the hole in the potato 12. It will be appreciated that the shank of the awl 72 has a slightly smaller diameter than the skewer 32, so that the skewer 32 is a press-fit in the hole.

An end of the skewer 32 is then inserted into the blind bore 48 of the chuck 44, the lid 36 being held by a user, separate from the sleeve 14. Thereafter, the potato 12 is slid on the skewer 32 towards the chuck 44 such that the prongs 52 pierce the potato 12, an end of the potato 12 bearing against the boss 50 of the chuck 44. When thus engaged with the chuck 44, the potato 12 is rotatable together with the chuck 44 about an axis of rotation 42 which is co-axial with the skewer 32, being keyed to the chuck 44 by engagement with the prongs 52.

The lid 36 is then connected to the upper end 22 of the sleeve 14, being locked to the sleeve 14 by engagement of the tabs 38 with their complementary locking niches 40. To receive the lid 36 on the sleeve 14, the skewer 32 is passed through the central aperture 58, so that the aperture 58 serves as a centering hole for ensuring that the skewer 32 is co-axial with the longitudinal axis 42 of the sleeve 14, and is thus co-axial with the axis of rotation 42 of the chuck 44.

It will be appreciated that the end of the potato 12 remote from the chuck bears against the blade disc 56 when the lid 36 is received on the sleeve 14 (see FIG. 3). The potato 12 thus forces the blade disc 56 and hence the carriage unit 16 as a whole downwardly away from the lid 36, against the urging of the compression spring 26. The spring 26 is therefore compressed by insertion of the potato 12 into the interior of the sleeve 14.

When a user rotates the handle 54 while the sleeve 14 is firmly gripped by a user and stands on a flat support surface, the potato 12 is turned into contact with the cutting edge 60 of the blade disc 56, so that the cutting edge 60 cuts into the potato 12. Due to the upward force exerted on the carriage unit 16 by the spring 26, the carriage unit 16 moves upwardly in response to cutting of the potato 12. Upward movement of the blade 56 is simultaneous to rotation of the potato 12, so that the potato 12 is thus sliced helically, or screw-fashion.

The blade 56 is prevented from rotating with the potato 12 by keying of the carriage body 34 to the sleeve 14, and by keying of the blade disc 56 to the carriage body 34. The skewer 32 and the potato 12 thus pass through the blade disc 56 as the potato 12 is rotated and the blade disc 56 slides upwardly along the sleeve 14. Differently defined, the potato 12 is inserted into a first compartment defined between the blade disc 56 and the lid 36, and screwingly passes through the blade disc 56 to a second compartment on the other side of the blade disc 56.

The pitch at which the potato 12 is cut, in other words the thickness of each slice of the potato 12, is determined by the size of the vertical gap at the cutting edge 60.

When the carriage unit 16 reaches an uppermost position (see FIG. 5), where a rim of the carriage body 34 bears against the lid 36, the blade disc 56 is stopped and is not displaced further longitudinally, so that the cutting edge 60 moves in a plane due to rotation of the handle 54, separating a base of the potato 12 from the helically sliced part of the potato 12. The potato 12 is thus cut into two separate pieces, namely the base which is engaged with the prongs 52, and a helically cut part on the other side of the blade disc 56.

A user can turn the sleeve 14 around, grip the free end of the skewer 32 through the open lower end 30 of the sleeve 14, and pull the skewer 32 from engagement with the chuck 44. The root end of the skewer 32 is pulled through the central aperture 58 in the blade disc 56, the helically sliced part of the potato 12, which has passed through the blade disc 56, being located on the skewer 32. The skewer 32 is thus pulled lengthwise through the severed base of the potato 12, leaving the base in engagement with the prongs 52 of the chuck 44.

The coils of the spirally cut potato 12 can then be spread on the skewer 32, and the potato 12 can be fried and eaten while still on the skewer 32.

To wash the blade disc 56, or to replace it, the locking ring 62 can be forced out of engagement with the splines 20 and the blade disc 56 can be slid downwardly away from the carriage body 34, the lugs 68 sliding along the grooves 66 in the splines 20. The opposite operation is followed to replace the blade disc 56, the locking ring 62 being snapped into position due to its resilient engagement with the locking formations 64 on the splines 20.

It is an advantage of a fruit or vegetable cutting device 10 as described with reference to the drawings that the device 10 is of relatively simple construction and is relatively cost-effective to manufacture, when compared to similar prior art devices. The device 10 further functions without the need for electrical power, being fully manually operated.

Furthermore, it is an advantage that a potato 12 cut by use of the device 10 is cut while already on a skewer 32, which facilitates handling of the helically cut potato 12. The potato 12 is also cut at a constant pitch due to the shape of the blade disc 56 and a constant, controlled urging force exerted by the compression spring 26.

I claim:

1. A device for slicing a fruit or vegetable in a helical shape, which device includes:
a frame;
a chuck which is connected or connectable to the frame, the chuck being rotatable relative to the frame about an axis of rotation and the chuck including a skewer holder for holding a skewer such that the skewer is more or less co-axial with the axis of rotation;
a keying means for rotationally keying to the chuck a fruit or vegetable on a skewer held by the skewer holder, so that the fruit or vegetable is rotatable with the chuck about the axis of rotation;
a blade member which is mounted on the frame for linear displacement in a direction parallel to the axis of rotation, the blade member having a cutting edge which extends more or less radially relative to the axis of rotation and the blade member being anchored against rotation relative to the frame, the blade member being mounted on a carriage which is longitudinally slidable along the frame;
an urging means for urging the carriage towards the chuck, the urging means including a spring means which act between the frame and the carriage; and
the blade member being shaped to abut a fruit or vegetable held on the chuck by the skewer, but to permit a part of the skewer to pass through the blade member, so that synchronous rotation and the chuck and linear displacement of the blade member results in helical slicing of a fruit or vegetable held on the chuck.

2. A device as claimed in claim 1, in which the blade member extends transversely to the axis of rotation of the chuck and includes a centering aperture which is co-axial with the axis of rotation, the centering aperture being configured for receiving a skewer held on the chuck, to ensure that the skewer is co-axial with the chuck's axis of rotation.

3. A device as claimed in claim 2, in which the frame is a tubular element having a hollow interior and open ends, the blade member being mounted or mountable in the hollow interior of the tubular element to extend transversely to a longitudinal axis of the tubular element, the blade member substantially closing off the hollow interior of the frame, to separate the interior of the frame into two compartments.

4. A device as claimed in claim 3, in which the blade member is a part-helical disc-shaped element in which the cutting edge is spaced from an adjacent edge of the element to define a cutting gap through which a cut portion of a fruit or vegetable can pass in response to rotation of the fruit or vegetable.

5. (canceled)

6. (canceled)

7. A device as claimed in claim 3, in which the carriage has a circumferentially spaced series of axially extending radially outwardly projecting splines for reception in complementary axially extending grooves in a radially inner wall of the frame, to permit sliding displacement of the carriage along the frame while keying the carriage to the frame.

8. A device as claimed in any one of claims 5, in which the blade member is removably and replaceably mounted on the carriage.

9. A device as claimed in claim 6, in which the carriage includes a locking member for holding the blade member in position on the carriage, the locking member being arranged for snap fit connection.

10. A device as claimed in claim 3, in which the chuck is provided on a removable closure member for reception on an upper end of the frame, the chuck projecting into the hollow interior of the frame and the device including a crank handle provided on an upper side of the closure member for manual operation, to rotate the chuck.

11. A device as claimed in claim 8, which includes a locking arrangement for locking the closure member to the upper end of the frame, to anchor the closure member against longitudinal displacement relative to the frame.

12. A device as claimed in claim 3, in which the tubular body of the frame is of a substantially transparent polymeric plastics material.

13. A device as claimed claim 1, in which the skewer holder comprises an elongated blind bore defined by the chuck, the bore being co-axial with the axis of rotation of the chuck.

14. A device as claimed claim 1, in which the keying means for keying a fruit or vegetable to the chuck comprises at least one keying protrusion which is fast with the chuck and projects axially from the chuck towards the interior of the frame for piercing a fruit or vegetable on a skewer held by the chuck.

15. A method of cutting a fruit or a vegetable in a helical shape, which method includes:
skewering the fruit or vegetable by passing a skewer through the fruit or vegetable;
mounting the skewer on a rotatable chuck of a cutting device such that the skewer is co-axial with an axis of rotation of the chuck, and passing a free end of the skewer, remote from the chuck, through a centering aperture in a blade member of the device, an end of the fruit or vegetable remote from the chuck bearing against the blade member;
keying the fruit or vegetable to the chuck for rotation therewith;
rotating the fruit or vegetable and the skewer in a cutting direction by rotating the chuck, so that the fruit or vegetable engages a cutting edge provided by the blade member; and
displacing the blade member along a frame towards the chuck during rotation of the chuck, the blade member being keyed against rotation about the axis of rotation, so that the fruit or vegetable is screwed through the blade member as the blade member moves upwards, the skewer passing through the blade member with the fruit or vegetable; and
removing the skewer, and therefore a helically cut part of the fruit or vegetable which is connected to the skewer, from the device by disengaging the skewer from the chuck.

16. (canceled)

17. A method as claimed in claim 15, in which the skewer and the helically cut part of the fruit or vegetable is removed from an end of a tubular body of the device opposite to an end of the device at which the chuck is located.

18. A method as claimed in claim 15, which includes urging the blade member towards the chuck by a spring means which acts between the blade member and the frame.
